(19) United States
(12) Patent Application Publication
(10) Pub. No.: US 2026/0171482 A1
(43) Pub. Date: Jun. 18, 2026

(54) BATTERY ELECTRODE LAYER ARRANGEMENTS

(71) Applicant: Valcon Labs, Inc., Milpitas, CA (US)

(72) Inventors: Bernd Ullmann, Pfinztal (DE); Jacob Matly, Milpitas, CA (US)

(21) Appl. No.: 19/125,218

(22) PCT Filed: Oct. 27, 2023
(86) PCT No.: PCT/US2023/036130

§ 371 Date: Apr. 28, 2025

Related U.S. Application Data
(60) Provisional application No. 63/420,085, filed on Oct. 28, 2022.

(51) Int. Cl. H01M 10/0562; H01M 4/02; H01M 4/38; H01M 4/66; H01M 10/0585; H01M 50/209; H01M 50/271; H01M 50/296; H01M 50/51; H01M 50/512; H01M 50/54

(52) U.S. Cl. CPC H01M 10/0562; H01M 4/382; H01M 4/661; H01M 10/0585; H01M 50/209; H01M 50/271; H01M 50/296; H01M 50/54; H01M 2004/021; H01M 2004/027; H01M 2004/028; H01M 50/51; H01M 50/512; H01M 2300/0074

(57) ABSTRACT

A battery unit comprises an arrangement of a plurality of stacked battery cells with individual battery cells including a number of discrete layers. The layers of the battery cells can include a solid-state separator layer. Dimensions of the battery cells are configured to minimize stress placed on one or more layers of the battery cells and to provide flexibility in the arrangements of battery cells to provide voltages and/or currents based on a load being driven by the battery cells.

### PRIORITY CLAIM

This application claims priority to U.S. Provisional Patent Application No. 63/420,085, filed Oct. 28, 2022, entitled BATTERY ELECTRODE LAYER ARRANGEMENTS, which is incorporated by reference herein in its entirety.

### BACKGROUND

Lithium-ion batteries are used in a variety of applications from smart phones to laptop computers to vehicles. Although lithium-ion batteries operate through the reversible reduction of lithium ions to store and release energy, the designs of lithium-ion batteries can vary based on the different end-uses for the lithium-ion batteries and based on characteristics of the components of the lithium-ion batteries.

### BRIEF DESCRIPTION OF THE DRAWINGS

FIG. 1 illustrates an example battery unit comprised of a number of battery cells having a ceramic separator layer, in accordance with one or more example implementations.

FIG. 2 is a diagram showing a side view of an example battery cell stack and a view of a top surface of a layer of the battery cell stack, in accordance with one or more example implementations.

FIG. 3 is a diagram of an example battery cell stack including a plurality of battery cells and having a first connector to couple cathode electrical contacts of the plurality of battery cells to a positively charged voltage source and a second connector to couple anode electrical contacts of the plurality of battery cells to a negatively charged voltage source, in accordance with one or more example implementations.

FIG. 4 is a diagram of an example battery cell stack including a plurality of battery cells and having a first connector to couple cathode electrical contacts of the plurality of battery cells to a positively charged voltage source and a second connector to couple anode electrical contacts of the plurality of battery cell stacks to a negatively charged voltage source, in accordance with one or more example implementations.

FIG. 5 is a diagram of an example battery unit including a plurality of battery cell stacks and having a first connector to couple cathode electrical contacts of the plurality of battery cell stacks to a positively charged voltage source and a second connector to couple anode electrical contacts of the plurality of battery cell stacks to a negatively charged voltage source, in accordance with one or more example implementations.

FIG. 6 is a diagram of an example battery unit including a plurality of battery cell stacks and having a first connector to couple anode electrical contacts of the plurality of battery cell stacks to a negatively charged voltage source and a second connector to couple cathode electrical contacts of the plurality of battery cell stacks to a positively charged voltage source, in accordance with one or more example implementations.

FIG. 7A illustrates a first example arrangement of connectors coupling a number of battery units, in accordance with one or more example implementations.

FIG. 7B illustrates a second example arrangement of connectors coupling a number of battery units, in accordance with one or more example implementations.

FIG. 8 is a flow diagram illustrating a process to produce a plurality of battery cell stacks and to produce a battery unit that includes the plurality of battery cell stacks, in accordance with one or more example implementations.

### DETAILED DESCRIPTION

In various scenarios, lithium-ion batteries are used in systems that are designed to operate at a relatively high voltage. In these situations, lithium-ion batteries are designed to increase the surface area of the electrodes in order to maximize the voltage supplied by the battery unit. In some cases, the batteries have a cylindrical shape and the battery layers are wound into a coil to provide a relatively high surface area that increases the voltage supplied by the battery unit. In other instances, the battery layers can be part of a stack of a prismatic battery unit. In these scenarios, dimensions of the individual battery layers can be maximized in order to achieve a desired voltage that is supplied by the battery unit. However, forming the battery layers in a cylindrical shape or having a prismatic battery shape with relatively large dimensions can limit the materials used in these batteries. For example, the separator layers of existing battery designs are typically formed from flexible, polymeric materials. These polymeric materials can suffer from limited thermal stability and poor compatibility with many electrolytes present in lithium-ion batteries. Additionally, polymeric separator layers can exhibit poor conductivity and have structural instability.

In one or more implementations, a lithium-ion battery unit comprises a number of battery cell stacks that include a number of battery cells. The battery cells include a number of discrete layers. To illustrate, the layers of the battery cells can include an anode current collector layer, an anode active material layer, a ceramic separator layer, a composite cathode-solid electrolyte layer, and a cathode current collector layer. The use of ceramic separator layers in implementations described herein can improve the thermal properties and structural properties of the separator layer with respect to existing lithium-ion battery designs that include polymeric separator layers. As a result of including ceramic separator layers in the battery cells described herein, the layers of the battery cells can be individually stacked, discrete layers. The stacked layers of the battery cells can supply voltages that are comparable to those of existing batteries without implementing a series of layers that are wound in a tortious path, such as cylindrical batteries, and without maximizing the dimensions of the layers, such as in prismatic batteries. Instead, implementing a battery stack having specified dimensions and ceramic separator layers can achieve the voltages being supplied for a variety of applications.

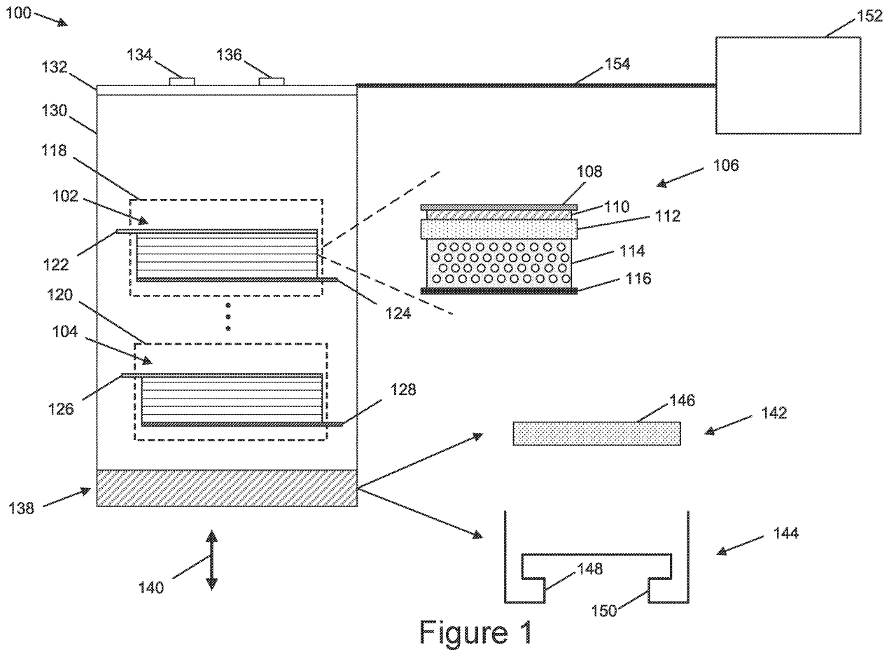

FIG. 1 illustrates an example battery unit 100 comprised of a number of battery cell stacks having ceramic separator layers, in accordance with one or more example implementations. For example, the battery unit 100 includes a first battery cell stack 102 up to an Nth battery cell stack 104. In one or more examples, the battery unit 100 can include from 2 battery cell stacks to 200 battery cell stacks, from 10 battery cell stacks to 100 battery cell stacks, from 50 battery cell stacks to 150 battery cell stacks, from 75 battery cell stacks to 125 battery cell stacks, from 100 battery cell stacks to 200 battery cell stacks, from 10 battery cell stacks to 30 battery cell stacks, from 20 battery cell stacks to 50 battery cell stacks, or from 150 battery cell stacks to 200 battery cell stacks. The battery cells of the battery unit 100 can comprise lithium-ion battery cells. In one or more illustrative examples, the battery cell stacks of the battery unit 100 can comprise solid electrolyte battery cells.

In one or more examples, the battery cell stacks 102, 104 can include a plurality of battery cells. In various examples, the battery cell stacks 102, 104 can individually include at least 2 battery cells, at least 5 battery cells, at least 10 battery cells, at least 25 battery cells, at least 50 battery cells, at least 75 battery cells, at least 100 battery cells, at least 125 battery cells, at least 150 battery cells, at least 175 battery cells, at least 200 battery cells, at least 250 battery cells, at least 300 battery cells, at least 350 battery cells, at least 400 battery cells, at least 450 battery cells, or at least 500 battery cells. In one or more illustrative examples, the battery cell stacks 102, 104 can individually include from 1 battery cell to 500 battery cells, from 5 battery cells to 400 battery cells, from 50 battery cells to 150 battery cells, from 150 battery cells to 300 battery cells, from 200 battery cells to 300 battery cells, from 250 battery cells to 400 battery cells, or from 300 battery cells to 500 battery cells.

In various examples, the first battery cell stack 102 can include a number of battery cells that correspond to example battery cell 106. The example battery cell 106 can include at least one of a number of substrates or a number of layers. In one or more examples, the battery cell 106 can include a first conductive substrate 108. In one or more the first conductive substrate 108 can comprise one or more metallic materials. In at least some examples, the first conductive substrate 108 can comprise copper, one or more alloys of copper, aluminum, one or more alloys of aluminum, or one or more combinations thereof. In at least some examples, the first conductive substrate 108 can be configured as a current collector. In one or more illustrative examples, the first conductive substrate 108 can have values of dimensions in the z-direction, such as a height, from about 2 micrometers (μm) to about 20 μm, from about 4 μm to about 16 μm, from about 8 μm to about 12 μm, from about 2 μm to about 10 μm, or from about 10 μm to about 20 μm.

In addition, the battery cell 106 can include an anode layer 110. In one or more examples, the anode layer 110 can include an anode active material layer. In one or more additional examples, the anode layer 110 can include a lithium-containing substrate. For example, the anode layer 110 can comprise a lithium foil disposed on a copper current collector substrate 108. In at least some examples, the anode layer 110 can be laminated on the first conductive substrate 108. In various examples, the anode layer 110 can be deposited on the first conductive substrate 108 using an electrochemical plating process. In one or more illustrative examples, the anode layer 110 can be deposited on the first conductive substrate 108 using a physical vapor deposition process. In one or more additional illustrative examples, the anode layer 110 can have values of dimensions in the z-direction, such as a height, from about 5 μm to about 40 μm, from about 10 μm to about 30 μm, from about 15 μm to about 25 μm, from about 20 μm to about 30 μm, or from about 10 μm to about 20 μm.

Further, the battery cell 106 can individually include a separator layer 112. The separator layer 112 can include one or more solid electrolyte materials. In one or more examples, the separator layer 112 can include one or more oxide ceramic materials. In one or more illustrative examples, the separator layer 112 can have an ionic conductivity from about 0.2 milliSiemens/centimeter (cm) to about 0.4 milliSiemens/cm at 25° C. In one or more additional illustrative examples, the separator layer 112 can be comprised one or more materials comprising Li₇La₃Zr₂O₁₂ (LLZO). In one or more further illustrative examples, the separator layer 112 can be comprised of LLZO doped with aluminum. In various examples, the separator layer 112 can be disposed on one or more additional layers of the battery cell 106 using a tape casting procedure. In at least some examples, the separator layer 112 can undergo one or more sintering processes after the tape casting process. The separator layer 112 can have values of dimensions in the z-direction, such as a height, from about 5 μm to about 40 μm, from about 10 μm to about 30 μm, from about 15 μm to about 25 μm, from about 20 μm to about 30 μm, or from about 10 μm to about 20 μm.

The battery cell 106 can also include a composite cathode-electrolyte layer 114. The composite cathode-electrolyte layer 114 can include a solid electrolyte. In one or more examples, the composite cathode-electrolyte layer 114 can include a solid electrolyte comprising one or more sulfide materials. In various examples, the composite cathode-electrolyte layer 114 can include a solid electrolyte having an ionic conductivity from about 2 milliSiemens/cm to about 8 milliSiemens / cm at 25° C. In one or more illustrative examples, the composite cathode-electrolyte layer 114 can comprise Li₆PS₅X, where X=Cl or Br. In at least some examples, the composite cathode-electrolyte layer 114 can comprise a solid electrolyte having particles with diameters from about 1 μm to about 12 μm.

Additionally, the composite cathode-separator layer 114 can include a cathode active material having a specific capacity of at least 200 milliamperes (mAh)/g. In one or more illustrative examples, the composite cathode-electrolyte layer 114 can include a cathode active material comprising nickel, cobalt, manganese, and lithium. In at least some examples, the composite cathode-electrolyte layer 114 can include a cathode active material comprising a NCM material, such as NCM 811. In various examples, the cathode-separator layer 114 can include a cathode active material having an oxide coating. In one or more illustrative examples, the composite cathode-electrolyte layer 114 can include a cathode active material having particles with diameters from about 1 μm to about 12 μm.

Further, the composite cathode-electrolyte layer 114 can include one or more additional materials, such as one or more binders and/or one or more conductive additives. In various examples, the composite cathode-electrolyte layer 114 can include conductive additives that comprise carbon. In one or more examples, the composite cathode-electrolyte layer 114 can have a porosity from about 1% by volume to about 20% by volume, from about 2% by volume to about 10% by volume, or from about 3% by volume to about 6% by volume. In addition, the composite cathode-electrolyte layer 114 can have from about 80% by weight to about 90% by weight of cathode active material and from about 5% by weight to about 15% by weight cathode active material. In still other examples, the composite cathode-electrolyte layer 114 can have from about 1% by weight to about 3% by weight of one or more binders and/or from about 1% by weight to about 3% by weight of one or more conductive additives. In one or more illustrative examples, the composite cathode-electrolyte layer 114 can have values of dimensions in the z-direction, such as a height, from about 100 μm to about 200 μm, from about 120 μm to about 180 μm, or from about 140 μm to about 160 μm.

Additionally, the battery cell 106 can include a second conductive substrate 116. The second conductive substrate 116 can comprise one or more metallic materials. In at least some examples, the second conductive substrate 116 can comprise copper, one or more alloys of copper, aluminum, one or more alloys of aluminum, or one or more combinations thereof. In at least some examples, the second conductive substrate 116 can be configured as a cathode current collector. In one or more illustrative examples, the second conductive substrate 116 can have values of dimensions in the z-direction, such as a height, from about 4 micrometers (μm) to about 30 μm, from about 8 μm to about 25 μm, from about 10 μm to about 20 μm, from about 20 μm to about 30 μm, or from about 15 pm to about 25 μm. In various examples, the composite cathode-electrolyte layer 114 can be applied to the second conductive substrate 116 as a slurry or as a paste using at least one of tape casting, extrusion, or screen printing techniques.

In one or more examples, the first battery cell stack 102 can be encased in a first shell 118 and the Nth battery cell 104 can be encased in a second shell 120. In various examples, the first shell 118 and the second shell 120 can be comprised of a foil. In one or more illustrative examples, the foil can be an electrically insulating foil. In at least some examples, the foil can be comprised of a polymeric material. For example, the first shell 118 and the second shell 120 can be comprised of a plastic foil. Additionally, the first battery cell stack 102 and the Nth battery cell stack 104 can include a number of tabs that are located outside of the first shell 118 and the second shell 120. To illustrate, the first battery cell stack 102 can include a first tab 122 and a second tab 124 and the Nth battery cell stack 104 can include a third tab 126 and a fourth tab 128. In at least some examples, the first tab 122 can include a cathode tab of the first battery cell stack 102 and the second tab 124 can include an anode tab of the first battery cell stack 102. Further, the third tab 126 can include a cathode tab of the Nth battery cell stack 104 and the fourth tab 128 can include an anode tab of the Nth battery cell stack 104.

The first battery cell stack 102 up to the Nth battery cell stack 104 can be disposed in a housing 130. The housing 130 can be comprised of one or more metallic materials. The housing 130 can include a lid 132. The lid 132 can be comprised of one or more metallic materials. Additionally, the lid 132 can be comprised of one or more polymeric materials. In one or more examples, the lid 132 can be coupled to a body of the housing 130. In various examples, the lid 132 can be coupled to a body of the housing 130 using one or more welding processes. For example, the lid 132 can be coupled to the body of the housing 130 using at least one of laser welding, ultrasonic vibration welding, or by friction welding. In various examples, the lid 132 can cover at least about 50%, at least about 60%, at least about 70%, at least about 80%, at least about 90%, at least about 95%, or at least about 99% of an opening in a body of the housing 130. In one or more further examples, the lid 132 can cover at least substantially all of an opening in a body of the housing 130.

The lid 132 can include a first electrical contact 134 and a second electrical contact 136. In one or more examples, the first electrical contact 134 can comprise an anode electrical contact and the second electrical contact 136 can comprise a cathode electrical contact. In at least some examples, the housing 130 can include an electrically insulating layer that electrically isolates the first contact 134 and the second contact 136 from the body of the housing 130. In one or more additional examples not shown in FIG. 1, the housing 130 can include a first electrical contact disposed in the lid 132 and a second electrical contact disposed at a bottom surface of the housing 130.

The housing 130 can also include a bottom component 138. In one or more examples, the bottom component 138 can comprise an open space or hollow portion of the housing 130. In various examples, the bottom component 138 can have a volume that corresponds to no greater than about 25%, no greater than about 20%, no greater than about 15%, no greater than about 10%, no greater than about 5%, or no greater than about 1% of the volume of the housing 130 occupied by the battery cell stacks disposed in the housing 130. The bottom component 138 can be designed in order to control, manage, and/or regulate, a pressure exerted on the battery cells located in the housing 130. The pressure exerted on the battery cells located in the housing 130 can be generated during the operation of the battery unit 100 in response to layers of the battery cells experiencing temperature changes during operation of the battery unit 100. For example, during operation of the battery unit 100, the layers of the battery cell stacks 102, 104 can experience an increased amount of heat. In various examples, the increased amount of heat can cause layers of the battery cells located in the housing 130 to expand. As the layers of the battery cells expand, the battery cells can press against each other and against the bottom component 138. At least a portion of the pressure exerted on the battery cells located in the housing 130 can correspond to a mechanical stress exerted in an axial direction 140.

The bottom component 138 can be designed such that the bottom component 138 absorbs at least some of the pressure that is produced by the expansion of layers of the battery cells during operation of the battery unit 100. The amount of pressure absorbed by the bottom component 138 can correspond to an amount that enables the battery cells to operate in a manner that maximizes the efficiency of the battery unit 100, but that also minimizes any damage to the layers of the battery cells located in the housing 130. For example, damage to ceramic separator layers of the battery cells included in the battery unit 130 can be minimized by the use of the bottom component 138.

The bottom component 138 can have a number of designs. For example, the bottom component 138 can have a first design 142 and a second design 144. The first design 142 can include disposing a device 146 in a bottom portion of the housing 130 that can operate as a spring-like mechanism with respect to the battery cells included in the housing 130. In one or more examples, the device 146 can comprise a cushion located on a bottom surface of the housing 130. In various examples, the cushion can be comprised of a foam. In one or more examples, the cushion can be adhered to the bottom surface of the housing 130 using one or more adhesives. In one or more additional examples, the device 146 can comprise an elastic component. In one or more further examples, the device 146 can comprise one or more springs.

In one or more additional examples, the second design 144 can comprise a first foot 148 and a second foot 150 formed from or attached to a bottom portion of the housing 130. The dimensions of the first foot 148 and the second foot 150 can be configured to cause the bottom surface of the housing to bend during operation of the battery unit 100. In various examples, the first foot 148 and the second foot 150 can be shaped such that an s-curved displacement is produced from the bottom of the feet 148, 150 to a lower surface of the housing 130.

The battery unit 100 can be coupled to a load 152 by one or more load connectors 154. In various examples, the load 152 can include an engine, a propulsion system, or a powertrain of a vehicle. In one or more illustrative examples, the vehicle can include an electrified vehicle. In one or more additional illustrative examples, the vehicle can include an urban air mobility (UAM) vehicle. The one or more load connectors 154 can be coupled to at least one of the first electrical contact 134 or the second electrical contact 136. In one or more illustrative examples, the load 152 can be coupled to the battery unit 100 by a first connector that is coupled to the first electrical contact 134 and a second connector that is coupled to the second electrical contact 136, where the first electrical contact 134 can include an anode electrical contact and the second electrical contact 136 can include a cathode electrical contact.

In one or more examples, the battery unit 100 can have a length, a width, and a height. In at least some examples, the length, the width, and the height of the battery unit 100 can have values that are within about 50% of each other, within about 55% of each other, within about 60% of each other, within about 65% of each other, within about 70% of each other, within about 75% of each other, within about 80% of each other, within about 85% of each other, within about 90% of each other, within about 95% of each other, or within about 99% of each other. In various examples, the length, width, and height of the battery unit 100 can have values that are substantially the same. In these scenarios, the battery unit 100 can have a shape of a cube or a shape that is substantially cubic. In one or more illustrative examples, the battery unit can have dimensions from about 10 mm to about 500 mm, from about 20 mm to about 400 mm, from about 30 mm to about 300 mm, from about 40 mm to about 200 mm, from about 50 mm to about 100 mm, from about 30 mm to about 80 mm, from about 40 mm to about 70 mm, from about 80 mm to about 150 mm, from about 100 mm to about 200 mm, or from about 200 mm to about 300 mm. In one or more additional illustrative examples, the battery unit 100 can have a length from about 40 mm to about 80 mm, a width from about 40 mm to about 80 mm, and a height from about 40 mm to about 80 mm. In one or more further illustrative examples, the battery unit 100 can have dimensions from about 40 mm to about 80 mm and that have values that are within at least about 90% of one another, at least about 95% of one another, or at least about 99% of one another. In still other examples, the housing 130 can have values of dimensions that minimize forces exerted on the layers of the battery cells included in the battery cell stacks 102, 104 that can damage the layers of the battery cells included in the battery cell stacks 102, 104. For example, the housing 130 can have values of dimensions that minimize forces exerted on at least one of the anode current collector layer, the anode active material layer, the ceramic separator layer, the cathode active material layer, or the cathode current collector layer. stack

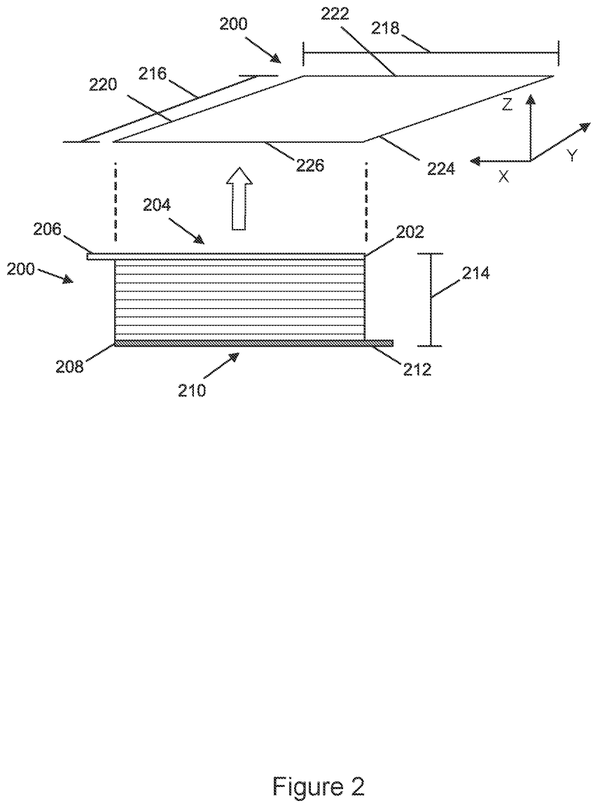

FIG. 2 is a diagram showing a side view of a battery cell stack 200 and a view of a top surface of a layer of the battery cell stack 200. The battery cell stack 200 can include a layer 202 that includes a functional area 204 and a tab 206. The battery cell 200 can also include an additional layer 208 that includes an additional functional area 210 and an additional tab 212. The functional area 204 of the layer 202 can include a portion of the layer 202 that excludes the tab 206 and the additional functional area 210 of the additional layer 208 can include a portion of the additional layer 208 that excludes the additional tab 212.

In various examples, the battery cell stack 200 can include a number of further layers between the layer 202 and the additional layer 206. In at least some examples, the battery cell stack 200 can include a number of battery cells with each battery cell comprised of a number of layers. For example, the battery cell stack 200 can include a number of battery cells that correspond to the battery cell 106 described with respect to FIG. 1. In one or more illustrative examples, the layer 202 can include a layer of an anode of a battery cell included in the battery cell stack 200 and the additional layer 208 can include a layer of a cathode of an additional battery cell included in the battery cell stack 200. In one or more additional illustrative examples, the layer 202 can include a current collector layer of an anode of a battery cell included in the battery cell stack 200 and the additional layer 208 can include a current collector layer of a cathode of an additional battery cell included in the battery cell stack 200.

The battery cell stack 200 can have dimensions in the x-direction, y-direction, and z-direction. In one or more examples, values of dimensions in the x-direction can correspond to widths, values of dimensions in the y-direction can correspond to lengths, and values in the z-direction can correspond to heights. In the illustrative example of FIG. 2, the battery cell stack 200 can have a height 214. In various examples, the height 214 can be measured from an outer surface of the layer 202 to an outer surface of the additional layer 208. In one or more illustrative examples, the height 214 can be from about 5 mm to about 100 mm, from about 10 mm to about 80 mm, from about 20 mm to about 60 mm, from about 30 mm to about 50 mm, from about 10 mm to about 40 mm, or from about 25 mm to about 50 mm.

In addition, the functional area 204 of the layer 202 can have a length 216 and a width 218. The length 216 can correspond to a measure of a first edge 220 and the width 218 can correspond to a measure of a second edge 222 that is disposed at least substantially perpendicular to the first edge 220. The length 216 can also correspond to a measure of a third edge 224 that is disposed at least substantially parallel to the first edge 220 and the width can also correspond to a measure of a fourth edge 226 that is at least substantially parallel with respect to the second edge 222 and at least substantially perpendicular with respect to the first edge 220 and the third edge 224.

In one or more examples, the length 216 can have values of at least 10 mm, at least 20 mm, at least 30 mm, at least 40 mm, at least 50 mm, at least 60 mm, at least 70 mm, at least 80 mm, at least 90 mm, at least 100 mm, at least 125 mm, at least 150 mm, at least 175 mm, or at least 200 mm. In one or more additional examples, the length 216 can have values from about from about 10 mm to about 200 mm, from about 20 mm to about 100 mm, from about 30 mm to about 80 mm, or from about 50 mm to about 70 mm. In one or more further examples, the width 218 can have values of at least 10 mm, at least 20 mm, at least 30 mm, at least 40 mm, at least 50 mm, at least 60 mm, at least 70 mm, at least 80 mm, at least 90 mm, at least 100 mm, at least 125 mm, at least 150 mm, at least 175 mm, or at least 200 mm. In still other examples, the width 216 can have values from about from about 10 mm to about 200 mm, from about 20 mm to about 100 mm, from about 30 mm to about 80 mm, or from about 50 mm to about 70 mm. In various examples, the length 216 can have values that are no greater than 0.5 times the values of the width 218, no greater than 0.6 times the values of the width 218, no greater than 0.7 times the values of the width 218, no greater than 0.8 times the values of the width 218, no greater than 0.9 times the values of the width 218, no greater than 0.95 times the values of the width 218, no greater than 0.99 times the values of the width 218, no greater than 1.05 times the values of the width 218, no greater than 1.1 times the values of the width 218, no greater than 1.2 times the values of the width 218, no greater than 1.3 times the values of the width 218, no greater than 1.4 times the values of the width 218, or no greater than 1.5 times the values of the width 218. In at least some examples, the length 216 and width 218 can have at least substantially the same value.

In at least some examples, at least a portion of the individual layers of the battery cell stack 200 can have different dimensions. Additionally, in various examples, the individual layers of the battery cell stack 200 can have dimensions that are proportional to one another. In one or more illustrative examples, the individual layers of the battery cell stack 200 can have lengths that are within about 50% to about 150% of one another, about 75% to about 125% of one another, about 80% to about 120% of one another, about 90% to about 110% of one another, about 95% to about 105% of one another, about 98% to about 102% of one another, and about 99% to about 101% of one another. In still other examples, the lengths of the individual layers of the battery cell stack 200 can be substantially the same. In one or more additional illustrative examples, the individual layers of the battery cell stack 200 can have widths that are within about 50% to about 150% of one another, about 75% to about 125% of one another, about 80% to about 120% of one another, about 90% to about 110% of one another, about 95% to about 105% of one another, about 98% to about 102% of one another, and about 99% to about 101% of one another. In one or more further illustrative examples, the widths of the individual layers of the battery cell stack 200 can be substantially the same.

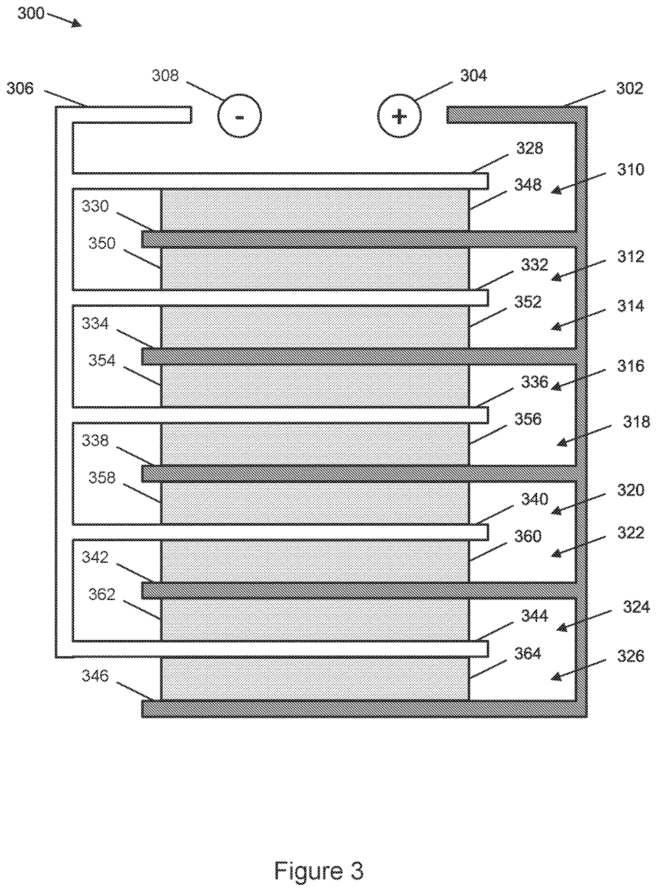

FIG. 3 is a diagram of a battery cell stack 300 including a plurality of battery cells and having a first connector 302 to couple cathode electrical contacts of the plurality of battery cells to a positively charged voltage source 304 and a second connector 306 to couple anode electrical contacts to of the plurality of battery cells to a negatively charged voltage source 308. The positively charged voltage source 304 and the negatively charged voltage source 308 can correspond to a load coupled to the battery unit 300. In the illustrative example of FIG. 3, the battery cell stack 300 can include a first battery cell 310, a second battery cell 312, a third battery cell 314, a fourth battery cell 316, a fifth battery cell 318, a sixth battery cell 320, a seventh battery cell 322, an eighth battery cell 324, and a ninth battery cell 326. Although the battery cell stack 300 of the illustrative example of FIG. 3 includes nine battery cells, in other implementations, the battery cell stack 300 can include more or fewer battery cells.

The battery cell stack 300 can include a first anode connector 328 that couples an anode of the first battery cell 310 to the second connector 306. In one or more examples, the first anode connector 328 can include an anode current collector layer of the first battery cell 310. In addition, the battery cell stack 300 can include a first cathode connector 330 that couples a cathode of the first battery cell stack 310 and a cathode of the second battery cell stack 312 to the first connector 302. In various examples, the first cathode connector 330 can include at least one of a cathode current collector layer of the first battery cell 310 or a cathode current collector layer of the second battery cell 312.

Additionally, the battery cell stack 300 can include a second anode connector 332 coupled to the second connector 306 and a second cathode connector 334 coupled to the first connector 302, In at least some examples, the second anode connector 332 can include at least one of an anode current collector layer of the second battery cell 312 or an anode current collector layer of the third battery cell 314. The second cathode connector 334 can include at least one of a cathode current collector layer of the third battery cell 314 or a cathode current collector layer of the fourth battery cell 318.

In one or more additional examples, the battery cell stack 300 can include a third anode connector 336 coupled to the second connector 306 and a third cathode connector 338 coupled to the first connector 302. The third anode connector 336 can include at least one of an anode current collector layer of the fourth battery cell 316 or an anode current collector layer of the fifth battery cell 318. The third cathode connector 338 can include at least one of a cathode current collector layer of the fifth battery cell 318 or a cathode current collector layer of the sixth battery cell 320. The battery cell stack 300 can also include a fourth anode connector 340 coupled to the second connector 306 and a fourth cathode connector 342 coupled to the first connector 302. The fourth anode connector 340 can include at least one of an anode current collector layer of the sixth battery cell 320 or an anode current collector layer of the seventh battery cell 322. The fourth cathode connector 342 can include at least one of a cathode current collector layer of the seventh battery cell 322 or a cathode current collector layer of the eighth battery cell 324.

Further, the battery unit 300 can include a fifth anode connector 344 coupled to the second connector 306 and a fifth cathode connector 346 coupled to the first connector 302. The fifth anode connector 344 can include at least one of an anode current collector layer of the eighth battery cell stack 324 or an anode current collector layer of the ninth battery cell stack 326. The fifth cathode connector 346 can include a cathode current collector layer of the ninth battery cell stack 326.

In various examples, a number of battery cell components can be coupled between the individual anode connectors and the individual cathode connectors. For example, the battery cell stack 300 can include a first additional component 348 disposed between the first anode connector 328 and the first cathode connector 330. In one or more examples, the first additional component 348 can include at least one of a separator layer, an anode active material layer, or a cathode active material layer. Additionally, the battery cell stack 300 can include a second additional component 350 disposed between the first cathode connector 330 and the second anode connector 332. In various examples, the second additional component 350 can include at least one of a separator layer, an anode active material layer, or a cathode active material layer. Further, the battery cell stack 300 can include a third additional component 352 disposed between the second anode connector 332 and the second cathode connector 334. In at least some examples, the third additional component 352 can include at least one of a separator layer, an anode active material layer, or a cathode active material layer.

The battery cell stack 300 can also include a fourth additional component 354 disposed between the second cathode connector 334 and the third anode connector 336. In one or more examples, the fourth additional component 354 can include at least one of a separator layer, an anode active material layer, or a cathode active material layer. In addition, the battery cell stack 300 can include a fifth additional component 356 disposed between the third anode connector 336 and the third cathode connector 338. In various examples, the fifth additional component 356 can include at least one of a separator layer, an anode active material layer, or a cathode active material layer. Further, the battery cell stack 300 can include a sixth additional component 358 disposed between the third cathode connector 338 and the fourth anode connector 340. In at least some examples, the sixth additional component 358 can include at least one of a separator layer, an anode active material layer, or a cathode active material layer.

In one or more examples, the battery cell stack 300 can also include a seventh additional component 360 disposed between the fourth anode connector 340 and the fourth cathode connector 342. In one or more examples, the seventh additional component 360 can include at least one of a separator layer, an anode active material layer, or a cathode active material layer. Additionally, the battery cell stack 300 can include an eighth additional component 362 disposed between the fourth cathode connector 342 and the fifth anode connector 344. In various examples, the eighth additional component 362 can include at least one of a separator layer, an anode active material layer, or a cathode active material layer. Further, the battery cell stack 300 can include a ninth additional component 364 disposed between the fifth anode connector 344 and the fifth cathode connector 346. In at least some examples, the ninth additional component 364 can include at least one of a separator layer, an anode active material layer, or a cathode active material layer.

In various examples, the battery cells of the battery cell stack 300 can be arranged in an alternating arrangement such that the disposition of each succeeding battery cell is reversed with respect to a preceding battery cell moving down from the voltage sources 304, 308 to the last battery cell 326. In at least some examples, the directionality of components of the battery cell stack 300 can be referred to as being at the top of a given battery cell when positioned closest to the voltage sources 304, 308 and as being at the bottom when positioned closest to the last layer of the ninth battery cell 326. For example, the first battery cell 310 can be positioned with one or more anode layers at the top of the first battery cell 310 and one or more cathode layers at the bottom of the first battery cell 310. In addition, the second battery cell 312 can have a reverse arrangement with one or more anode layers of the second battery cell 312 being positioned at the bottom of the second battery cell 312 and one or more cathode layers of the second battery cell 312 being positioned at the top of the second battery cell 312. Further, the third battery cell 314 can have a same arrangement as the first battery cell 310 and a reverse arrangement with respect to the second battery cell 312. To illustrate, the third battery cell 314 can include one or more anode layers of the third battery cell 314 at the top of the third battery cell 314 and one or more cathode layers of the third battery cell 314 at the bottom of the third battery cell 314. This arrangement of battery cells of the battery cell stack 300 can continue until the ninth battery cell stack 326 is positioned with one or more anode layers of the ninth battery cell 326 positioned at the top of the ninth battery cell 326 and one or more cathode layers of the ninth battery cell 326 located at the bottom of the ninth battery cell 326. This arrangement can result in efficiencies with respect to the number of connectors coupled to the first connector 302 and the second connector 306 because, at least in some cases, a single connector can be used to couple one or more anode layers of two battery cells to the second connector 306 and a single connector can be used to couple one or more cathode layers of two battery cells to the first connector 302 rather than using two connectors to couple one or more anode layers of two battery cells to the second connector 306 and multiple connectors to couple one or more cathode layers of two battery cells to the first connector 304.

In at least some examples, the arrangement of battery cells in the battery cell stack 300 can result in the battery cell stack 300 maximizing an amount of current that can be supplied to a load. For example, the individual battery cells can be configured to supply a given amount of current to a load. Based on the arrangement of battery cells in the battery cell stack 300, the amount of current supplied can be proportional to the number of battery cells included in the battery cell stack 300. Thus, as the number of battery cells included in the battery cell stack 300 increases, the amount of current supplied to the load can increase. In one or more illustrative examples, individual battery cells of the battery cell stack 300 can be configured to individually supply from 0.05 ampere-hours (Ah) to 1 Ah of current to a load, from 0.1 Ah to 0.9 Ah of current to a load, from 0.2 Ah to 0.8 Ab of current to a load, from 0.3 Ah to 0.7 Ah of current to a load, of from 0.4 Ah to 0.6 Ah of current to a load. In one or more examples, the amount of current supplied by the individual battery cells and the battery cell stack 300 can be expressed as an energy capacity. In one or more additional illustrative examples, the battery cell stack 300 can have an energy capacity of at least 5 Ah, at least 10 Ah, at least 20 Ah, at least 30 Ah, at least 40 Ah, at least 50 Ah, at least 75 Ah, at least 100 Ah, at least 125 Ah, at least 150 Ah, at least 175 Ah, at least 200 Ah, at least 225 Ah, or at least 250 Ah.

Additionally, the arrangement of battery cells in the battery cell stack 300, can supply a voltage to a load that corresponds to a voltage supplied by the individual battery cells. To illustrate, the battery cells 310, 312, 314, 316, 318, 320, 322, 324, 326 can individually supply a voltage of about 3.65 volts (V) to a load and the battery cell stack 300 can supply a voltage of about 3.65 V to the load. In various examples, the voltage supplied to the load can be expressed as a mean discharge potential. In one or more illustrative examples, the battery cell stack 300 and the individual battery cells 310, 312, 314, 316, 318, 320, 322, 324, 326 can supply from 0.5 V to 10 V to a load, from 1 V to 9 V to a load, from 2 V to 8 V to a load, from 3 V to 7 V to a load, from 1 V to 5 V to a load, from 3 V to 4 V to a load, from 2 V to 4 V to a load, from 5 V to 10 V to a load, from 6 V to 8 V to a load, or from 7 V to 9 V to a load.

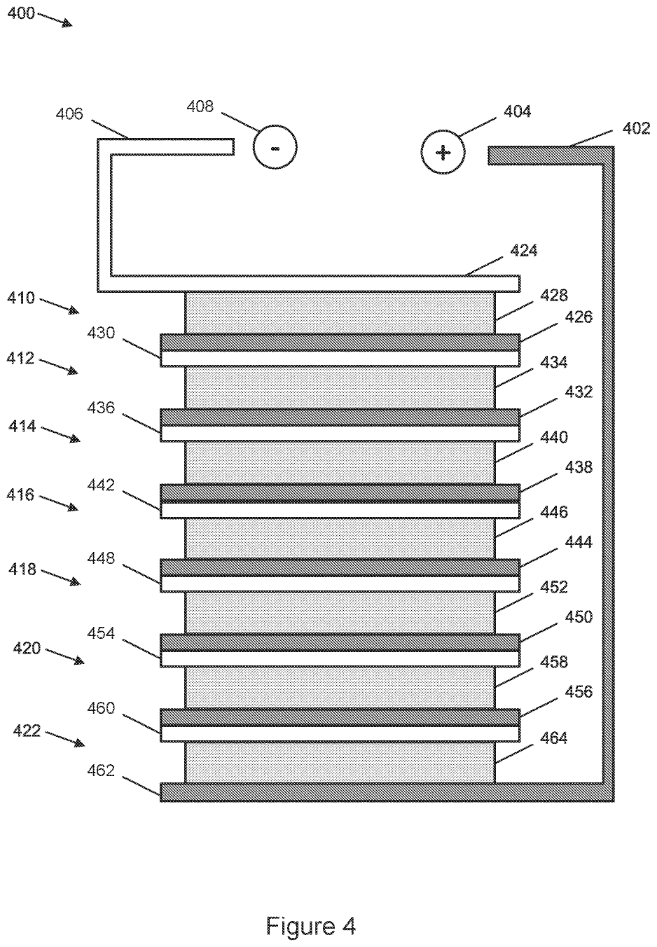

FIG. 4 is a diagram of a battery cell stack 400 including a plurality of battery cells and having a first connector 402 to couple cathode electrical contacts of the plurality of battery cells to a positively charged voltage source 404 and a second connector 406 to couple anode electrical contacts to of the plurality of battery cell stacks to a negatively charged voltage source 408. The battery cell stack 400 can include a first battery cell 410, a second battery cell 412, a third battery cell 414, a fourth battery cell 416, a fifth battery cell 418, a sixth battery cell 420, and a seventh battery cell 422. The first battery cell 410 can include a first anode current collector layer 424 and a first cathode current collector layer 426. The first battery cell 410 can also include a first additional component 428 disposed between the first anode current collector layer 424 and the first cathode current collector layer 426. The first additional component 428 can include at least one of a separator layer, an anode active material layer, or a cathode active material layer. In one or more examples, the first anode current collector layer 424 can be coupled to the second connector 406. The second battery cell 412 can include a second anode current collector layer 430 and a second cathode current collector layer 432. Additionally, the second battery cell 412 can include a second additional component 434 that is disposed between the second anode current collector layer 430 and the second cathode current collector layer 432. The second additional component 434 can include at least one of a separator layer, an anode active material layer, or a cathode active material layer. The third battery cell 414 can include a third anode current collector layer 436 and a third cathode current collector layer 438. In various examples, the third battery cell 414 can include a third additional component 440 that is disposed between the third anode current collector layer 436 and the third cathode current collector layer 438. The third additional component 440 can include at least one of a separator layer, an anode active material layer, or a cathode active material layer.

The fourth battery cell 416 can include a fourth anode current collector layer 442 and a fourth cathode current collector layer 444. The fourth battery cell 416 can include a fourth additional component 446 disposed between the fourth anode current collector layer 442 and the fourth cathode current collector layer 444. The fourth additional component 446 can include at least one of a separator layer, an anode active material layer, or a cathode active material layer. In addition, the fifth battery cell 418 can include a fifth anode current collector layer 448 and a fifth cathode current collector layer 450. The fifth battery cell 418 can include a fifth additional component 452 disposed between the fifth anode current collector layer 448 and the fifth cathode current collector layer 450. The fourth additional component 452 can include at least one of a separator layer, an anode active material layer, or a cathode active material layer. In one or more examples, the sixth battery cell 420 can include a sixth anode current collector layer 454 and a sixth cathode current collector layer 456. The sixth battery cell 420 can include a sixth additional component 458 disposed between the sixth anode current collector layer 454 and the sixth cathode current collector layer 456. The sixth additional component 458 can include at least one of a separator layer, an anode active material layer, or a cathode active material layer. In various examples, the seventh battery cell 422 can include a seventh anode current collector layer 460 and a seventh cathode current collector layer 462. The seventh battery cell 422 can include a seventh additional component 464 disposed between the seventh anode current collector layer 460 and the seventh cathode current collector layer 462. The seventh additional component 464 can include at least one of a separator layer, an anode active material layer, or a cathode active material layer. Further, the seventh cathode current collector layer 462 can be coupled to the first connector 402.

In at least some examples, the arrangement of battery cells in the battery cell stack 400 can result in the battery cell stack 400 maximizing an amount of voltage that can be supplied to a load. For example, the individual battery cells can be configured to supply a given amount of voltage to a load. Based on the arrangement of battery cells in the battery cell stack 400, the amount of voltage supplied can be proportional to the number of battery cells included in the battery cell stack 400. Thus, as the number of battery cells included in the battery cell stack 400 increases, the amount of voltage supplied to the load can increase. In one or more illustrative examples, individual battery cells of the battery cell stack 400 can be configured to individually supply from 0.5 V to 10 V to a load, from 1 V to 9 V to a load, from 2 V to 8 V to a load, from 3 V to 7 V to a load, from 1 V to 5 V to a load, from 3 V to 4 V to a load, from 2 V to 4 V to a load, from 5 V to 10 V to a load, from 6 V to 8 V to a load, or from 7 V to 9 V to a load. In one or more examples, the amount of voltage supplied by the individual battery cells and the battery cell stack 400 can be expressed as a mean discharge potential. In one or more additional illustrative examples, the battery cell stack 400 can have a mean discharge potential from about 3 V to about 300 V, from about 10 V to about 250 V, from about 25 V to about 200 V, from about 50 V to about 150 V, from about 25 V to about 50 V, from about 50 V to about 100 V, from about 100 V to about 200 V, or from about 25 V to about 75 V.

Additionally, the arrangement of battery cells in the battery cell stack 400, can supply current to a load that corresponds to a current supplied by the individual battery cells. To illustrate, the battery cells 410, 412, 414, 416, 418, 420, 422 can individually supply a current of about 0.25 Ah to a load and the battery cell stack 400 can supply a current of about 0.25 Ah to the load. In various examples, the current supplied to the load can be expressed as an energy capacity. In one or more illustrative examples, the battery cell stack 400 and the individual battery cells 410, 412, 414, 416, 418, 420, 422 can be configured to individually supply from 0.05 ampere-hours (Ah) to 1 Ah of current to a load, from 0.1 Ah to 0.9 Ah of current to a load, from 0.2 Ah to 0.8 Ah of current to a load, from 0.3 Ah to 0.7 Ah of current to a load, of from 0.4 Ah to 0.6 Ah of current to a load.

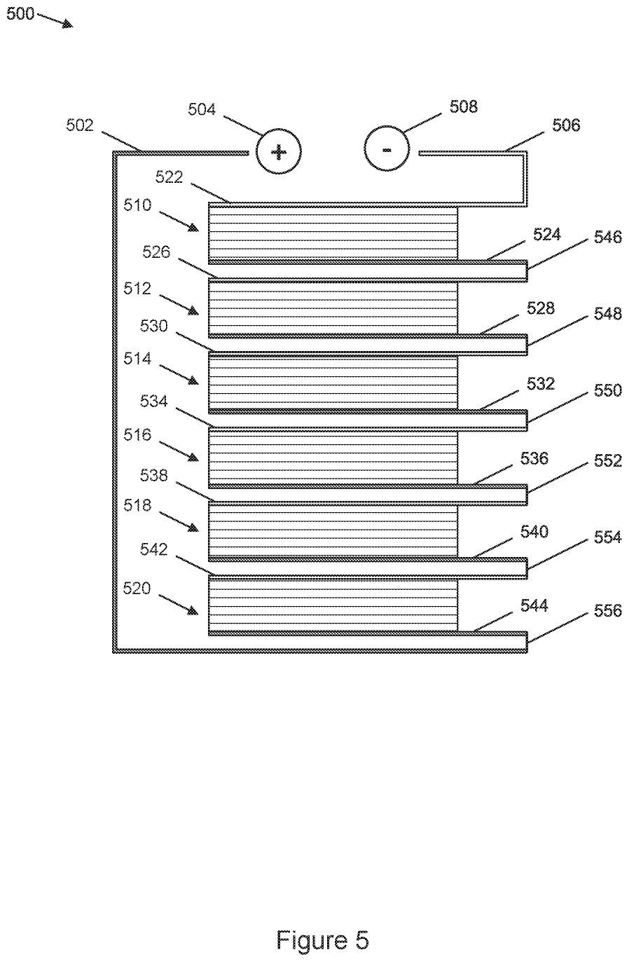

FIG. 5 is a diagram of a battery unit 500 including a plurality of battery cell stacks and having a first connector 502 to couple cathode electrical contacts of the plurality of battery cell stacks to a positively charged voltage source 504 and a second connector 506 to couple anode electrical contacts to of the plurality of battery cell stacks to a negatively charged voltage source 508. The battery unit 500 can include a first battery cell stack 510, a second battery cell stack 512, a third battery cell stack 514, a fourth battery cell stack 516, a fifth battery cell stack 518, and a sixth battery cell stack 520. Although the illustrative example of FIG. 5 includes a battery unit 500 having six battery cell stacks, in other implementations, the battery unit 500 can include more or fewer battery cell stacks.

The individual battery cell stacks 510, 512, 514, 516, 518, 520 can include a plurality of battery cells. In one or more illustrative examples, the battery cell stacks 510, 512, 514, 516, 518, 520 individually can include from 2 battery cells to 200 battery cells, from 5 battery cells to 100 battery cells, from 10 battery cells to 80 battery cells, from 20 battery cells to 60 battery cells, from 30 battery cells to 50 battery cells, from 2 battery cells to 20 battery cells, from 5 battery cells to 15 battery cells, from 2 battery cells to 10 battery cells, or from 10 battery cells to 25 battery cells. In one or more examples, the individual battery cells stacks 510, 512, 514, 516, 518, 520 can include a same number of battery cells. In one or more additional examples, the individual battery cell stacks at least two of the 510, 512, 514, 516, 518, 520 can include a different number of battery cells. In one or more illustrative examples, the individual battery cell stacks 510, 512, 514, 516, 518, 520 can comprise one or more implementations of the battery cells described with respect to FIG. 3. That is, in various examples, the battery cells stacks 510, 512, 514, 516, 518, 520 can individually include an arrangement of battery cells 300 described with respect to FIG. 3.

In one or more examples, the first battery cell stack 510 can include a first anode connector 522 and a first cathode connector 524. In at least some examples, the first anode connector 522 can be coupled to the second connector 506. In various examples, the first anode connector 522 can include or be coupled to one or more anode current collector layers of the battery cells included in the first battery cell stack 510 and the first cathode connector 524 can include or be coupled to one or more cathode current collector layers of the battery cells included in the first battery cell stack 510. In addition, the second battery cell stack 512 can include a second anode connector 526 and a second cathode connector 528. In one or more further examples, the second anode connector 526 can include or be coupled to one or more anode current collector layers of the battery cells included in the second battery cell stack 512 and the second cathode connector 528 can include or be coupled to one or more cathode current collector layers of the battery cells included in the second battery cell stack 512. Further, the third battery cell stack 514 can include a third anode connector 530 and a third cathode connector 532. In one or more examples, the third anode connector 530 can include or be coupled to one or more anode current collector layers of the battery cells included in the third battery cell stack 514 and the third cathode connector 532 can include or be coupled to one or more cathode current collector layers of the battery cells included in the third battery cell stack 514.

The fourth battery cell stack 516 can include a fourth anode connector 534 and a fourth cathode connector 536. In various examples, the fourth anode connector 534 can include or be coupled to one or more anode current collector layers of the battery cells included in the fourth battery cell stack 516 and the fourth cathode connector 536 can include or be coupled to one or more cathode current collector layers of the battery cells included in the fourth battery cell stack 516. In addition, the fifth battery cell stack 518 can include a fifth anode connector 538 and a fifth cathode connector 540. In one or more further examples, the fifth anode connector 538 can include or be coupled to one or more anode current collector layers of the battery cells included in the fifth battery cell stack 518 and the fifth cathode connector 540 can include or be coupled to one or more cathode current collector layers of the battery cells included in the fifth battery cell stack 518. Further, the sixth battery cell stack 520 can include a sixth anode connector 542 and a sixth cathode connector 544. In one or more examples, the sixth anode connector 542 can include or be coupled to one or more anode current collector layers of the battery cells included in the sixth battery cell stack 520 and the sixth cathode connector 544 can include or be coupled to one or more cathode current collector layers of the battery cells included in the sixth battery cell stack 520. Additionally, the sixth cathode connector 544 can be coupled to the first connector 502.

The battery unit 500 can also include a first battery cell stack connector 546 that couples the first cathode connector 524 to the second anode connector 526. In addition, the battery unit 500 can include a second battery cell stack connector 548 that couples the second cathode connector 528 to the third anode connector 530. Further, the battery unit 500 can include a third battery cell stack connector 550 that couples the third cathode connector 532 to the fourth anode connector 534. In various examples, the battery unit 500 can include a fourth battery cell stack connector 552 that couples the fourth cathode connector 536 to the fifth anode connector 538. In one or more examples, the battery unit 500 can include a fifth battery cell stack connector 554 that couples the fifth cathode connector 540 to the sixth anode connector 542. In still other examples, the battery unit 500 can include a sixth battery cell stack connector 556 that couples the sixth cathode connector 544 to the first connector 502.

In one or more illustrative examples, the connectors described with respect to the battery unit 500 can be comprised of one or more metallic materials. In at least some illustrative examples, the cathode connectors can comprise one or more aluminum-containing materials and the anode connectors can comprise one or more copper-containing materials. In one or more additional illustrative examples, the battery unit 500 can supply a voltage to a load that corresponds to the number of battery cell stacks included in the battery unit 500. For example, as the number of battery cell stacks included in the battery unit 500 increases, the voltage supplied by the battery unit 500 to a load also increases. In one or more further illustrative examples, the battery unit 500 can supply from 4 V to 400 V to a load, from 10 V to 300 V to a load, from 20 V to 200 V to a load, from 50 V to 100 V to a load, from 10 V to 50 V to a load, from 100 V to 200 V to a load, from 200 V to 300 V to a load, or from 300 V to 400 V to a load. In this way, the battery unit 500 can maximize a voltage supplied to a load by increasing a number of battery cell stacks included in the battery unit 500. Additionally, a current supplied to a load by the battery unit 500 can correspond to a current supplied by a single battery cell stack. In one or more further illustrative examples, the current supplied to a load by the battery unit 500 can be from 1 Ah to 100 Ah, from 2 Ah to 50 Ah, from 5 Ah to 30 Ah, from 10 Ah to 20 Ah, from 1 Ah to 5 Ah, from 5 Ah to 10 Ah, from 10 Ab to 50 Ah, from 50 Ah to 100 Ah, or from 2 Ah to 8 Ah.

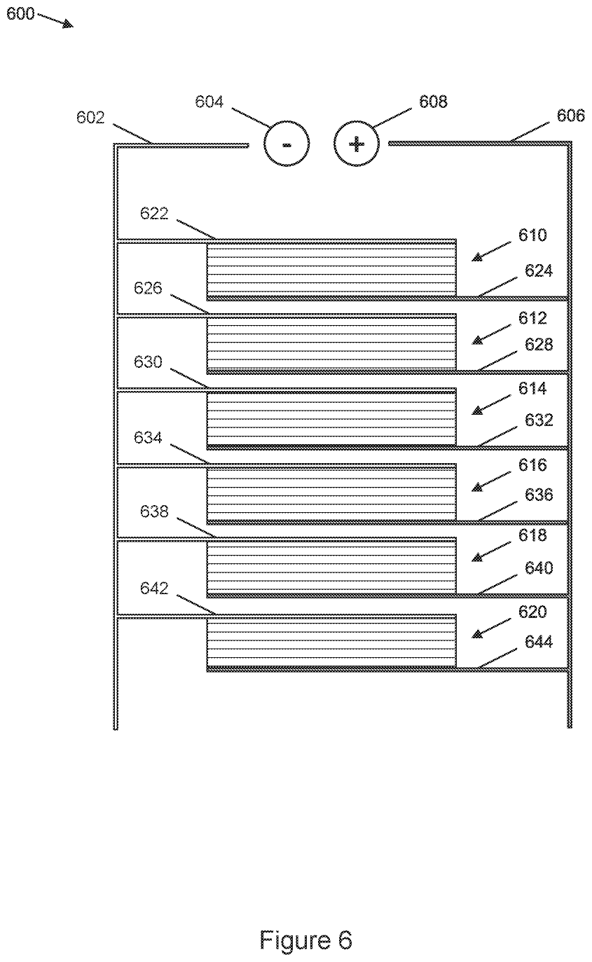

FIG. 6 is a diagram of a battery unit 600 including a plurality of battery cell stacks and having a first connector 602 to couple anode electrical contacts of the plurality of battery cell stacks to a negatively charged voltage source 604 and a second connector 606 to couple cathode electrical contacts to of the plurality of battery cell stacks to a positively charged voltage source 608. The battery unit 600 can include a first battery cell stack 610, a second battery cell stack 612, a third battery cell stack 614, a fourth battery cell stack 616, a fifth battery cell stack 618, and a sixth battery cell stack 620. Although the illustrative example of FIG. 6 includes a battery unit 600 having six battery cell stacks, in other implementations, the battery unit 600 can include more or fewer battery cell stacks.

The individual battery cell stacks 610, 612, 614, 616, 618, 620 can include a plurality of battery cells. In one or more illustrative examples, the battery cell stacks 610, 612, 614, 616, 618, 620 individually can include from 2 battery cells to 200 battery cells, from 5 battery cells to 100 battery cells, from 10 battery cells to 80 battery cells, from 20 battery cells to 60 battery cells, from 30 battery cells to 50 battery cells, from 2 battery cells to 20 battery cells, from 5 battery cells to 15 battery cells, from 2 battery cells to 10 battery cells, or from 10 battery cells to 25 battery cells. In one or more examples, the individual battery cells stacks 610, 612, 614, 616, 618, 620 can include a same number of battery cells. In one or more additional examples, the individual battery cell stacks at least two of the 610, 612, 614, 616, 618, 620 can include a different number of battery cells. In one or more illustrative examples, the individual battery cell stacks 610, 612, 614, 616, 618, 620 can comprise one or more implementations of the battery cells described with respect to FIG. 4. That is, in various examples, the battery cells stacks 610, 612, 614, 616, 618, 620 can individually include an arrangement of battery cells 400 described with respect to FIG. 4.

In one or more examples, the first battery cell stack 610 can include a first anode connector 622 and a first cathode connector 624. In at least some examples, the first anode connector 622 can be coupled to the first connector 602 and the first cathode connector 624 can be coupled to the second connector 606. In various examples, the first anode connector 622 can include or be coupled to one or more anode current collector layers of the battery cells included in the first battery cell stack 610 and the first cathode connector 624 can include or be coupled to one or more cathode current collector layers of the battery cells included in the first battery cell stack 610. In addition, the second battery cell stack 612 can include a second anode connector 626 and a second cathode connector 628. The second anode connector 626 can be coupled to the first connector 602 and the second cathode connector 628 can be coupled to the second connector 606. In one or more further examples, the second anode connector 626 can include or be coupled to one or more anode current collector layers of the battery cells included in the second battery cell stack 612 and the second cathode connector 628 can include or be coupled to one or more cathode current collector layers of the battery cells included in the second battery cell stack 612. Further, the third battery cell stack 614 can include a third anode connector 630 and a third cathode connector 632. The third anode connector 630 can be coupled to the first connector 602 and the third cathode connector 632 can be coupled to the second connector 606. In one or more examples, the third anode connector 630 can include or be coupled to one or more anode current collector layers of the battery cells included in the third battery cell stack 614 and the third cathode connector 632 can include or be coupled to one or more cathode current collector layers of the battery cells included in the third battery cell stack 614.

The fourth battery cell stack 616 can include a fourth anode connector 634 and a fourth cathode connector 536. The fourth anode connector 634 can be coupled to the first connector 602 and the fourth cathode connector 636 can be coupled to the second connector 606. In various examples, the fourth anode connector 634 can include or be coupled to one or more anode current collector layers of the battery cells included in the fourth battery cell stack 616 and the fourth cathode connector 636 can include or be coupled to one or more cathode current collector layers of the battery cells included in the fourth battery cell stack 616. In addition, the fifth battery cell stack 618 can include a fifth anode connector 638 and a fifth cathode connector 640. In at least some examples, the fifth anode connector 638 can be coupled to the first connector 602 and the fifth cathode connector 640 can be coupled to the second connector 606. In one or more further examples, the fifth anode connector 638 can include or be coupled to one or more anode current collector layers of the battery cells included in the fifth battery cell stack 618 and the fifth cathode connector 640 can include or be coupled to one or more cathode current collector layers of the battery cells included in the fifth battery cell stack 618. Further, the sixth battery cell stack 620 can include a sixth anode connector 642 and a sixth cathode connector 644. In one or more examples, the sixth anode connector 642 can include or be coupled to one or more anode current collector layers of the battery cells included in the sixth battery cell stack 620 and the sixth cathode connector 644 can include or be coupled to one or more cathode current collector layers of the battery cells included in the sixth battery cell stack 620. The sixth anode connector 642 can be coupled to the first connector 602 and the sixth cathode connector 644 can be coupled to the second connector 606.

In one or more illustrative examples, the connectors described with respect to the battery unit 600 can be comprised of one or more metallic materials. In at least some illustrative examples, the cathode connectors can comprise one or more aluminum-containing materials and the anode connectors can comprise one or more copper-containing materials. In one or more additional illustrative examples, the battery unit 600 can supply current to a load that corresponds to the number of battery cell stacks included in the battery unit 600. For example, as the number of battery cell stacks included in the battery unit 600 increases, the current supplied by the battery unit 600 to a load also increases. In one or more further illustrative examples, the battery unit 600 can supply from 0.5 Ah to 50 Ah to a load, from 1 Ah to 40 Ah to a load, from 2 Ah to 30 Ah to a load, from 5 Ah to 20 Ah to a load, from 2 Ah to 5 Ah to a load, from 2 Ah to 10 Ah to a load, from 5 Ah to 10 Ah to a load, from 10 Ah to 20 Ah to a load, from 15 Ah to 25 Ah to a load, or from 20 Ah to 30 Ah to a load. In this way, the battery unit 600 can maximize a current supplied to a load by increasing a number of battery cell stacks included in the battery unit 600. Additionally, a current supplied to a load by the battery unit 600 can correspond to a voltage supplied by a single battery cell stack. In one or more further illustrative examples, the voltage supplied to a load by the battery unit 600 can be from 2 V to 200 V, from 5 V to 150 V, from 10 V to 100 V, from 20 V to 50 V, from 10 V to 30 V, from 30 V to 50 V, from 40 V to 60 V, from 50 V to 100 V, from 60 V to 80 V, from 100 V to 125 V, from 125 V to 150 V, from 150 V to 175 V, or from 175 V to 200 V.

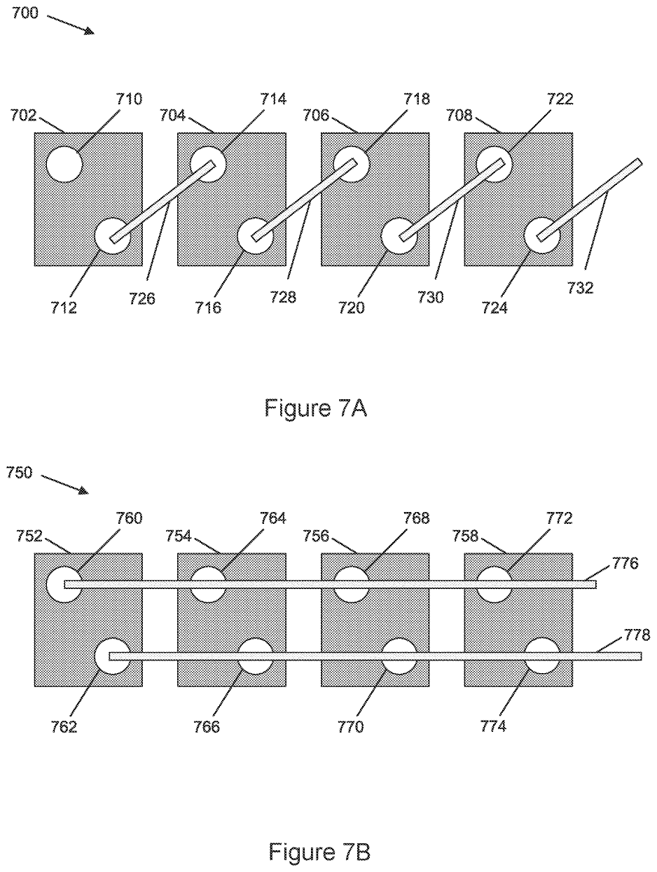

FIG. 7A illustrates a first arrangement 700 of connectors coupling a number of battery units. For example, the first arrangement 700 can include a top portion of a first battery unit 702, a top portion of a second battery unit 704, a top portion of a third battery unit 706, and a top portion of a fourth battery unit 708. In various examples, the respective top portions of the battery units 702, 704, 706, 708 can include a lid of the battery units 702, 704, 706, 708. Although the first arrangement 700 includes four battery units, in other implementations, the first arrangement 700 can include fewer or more battery units.

The top portion of the first battery unit 702 can include a first cathode electrical contact 710 and a first anode electrical contact 712 and the top portion of the second battery unit 704 can include a second cathode electrical contact 714 and a second anode electrical contact 716. Additionally, the top portion of the third battery unit 706 can include a third cathode electrical contact 718 and a third anode electrical contact 720 and a top portion of the fourth battery unit 708 can include a fourth cathode electrical contact 722 and a fourth anode electrical contact 724.

In one or more illustrative examples, the cathode electrical contacts 710, 714, 718, 722 can be coupled to at least one of the first connector 502 described with respect to FIG. 5 or the second connector 606 described with respect to FIG. 6 and that anode electrical contacts 712, 716, 720, 724 can be coupled to at least one of the second connector 506 described with respect to FIG. 5 or the first connector 602 described with respect to FIG. 6.

In one or more illustrative examples, a first battery unit connector 726 can couple the first anode electrical contact 712 to the second cathode electrical contact 714. Additionally, a second battery unit connector 728 can couple the second anode electrical contact 716 to the third cathode electrical contact 718. Further, a third battery unit connector 730 can couple the third anode electrical contact 720 to the fourth cathode electrical contact 722. In various examples, a fourth battery unit connector 732 can be coupled to the fourth anode electrical contact 724 and can couple the fourth anode electrical contact 724 to an additional cathode electrical contact of an additional battery unit not shown in FIG. 7A or to a negatively charged voltage source not shown in the illustrative example of FIG. 7A. Although the illustrative example of FIG. 7A shows no connector coupled to the first cathode electrical contact, the first cathode electrical contact can be coupled to an additional battery unit not shown in the illustrative example of FIG. 7A or to a positively charged voltage source not shown in the illustrative example of FIG. 7A.

FIG. 7B illustrates a second arrangement 750 of connectors coupling a number of battery units. For example, the second arrangement 750 can include a top portion of a first battery unit 752, a top portion of a second battery unit 754, a top portion of a third battery unit 756, and a top portion of a fourth battery unit 758. In various examples, the respective top portions of the battery units 752, 754, 756, 758 can include a lid of the battery units 752, 754, 756, 758. Although the second arrangement 750 includes four battery units, in other implementations, the second arrangement 750 can include fewer or more battery units.

The top portion of the first battery unit 752 can include a first cathode electrical contact 760 and a first anode electrical contact 762 and the top portion of the second battery unit 754 can include a second cathode electrical contact 764 and a second anode electrical contact 766. Additionally, the top portion of the third battery unit 756 can include a third cathode electrical contact 768 and a third anode electrical contact 770 and a top portion of the fourth battery unit 758 can include a fourth cathode electrical contact 772 and a fourth anode electrical contact 774.

In one or more illustrative examples, the cathode electrical contacts 760, 764, 768, 772 can be coupled to at least one of the first connector 502 described with respect to FIG. 5 or the second connector 606 described with respect to FIG. 6 and that anode electrical contacts 762, 766, 770, 774 can be coupled to at least one of the second connector 506 described with respect to FIG. 5 or the first connector 602 described with respect to FIG. 6.

In one or more illustrative examples, a first battery unit connector 776 can couple the first cathode electrical contact 760, the second cathode electrical contact 764, the third cathode electrical contact 768, and the fourth cathode electrical contact 772 to one another. The first battery unit connector 776 can also couple the electrical contacts 760, 764, 768, 772 to a positively charged voltage source. In one or more additional illustrative examples, a second battery unit connector 778 can couple the first anode electrical contact 762, the second anode electrical contact 766, the third anode electrical contact 770, and the fourth anode electrical contact 774 to one another. The second battery unit connector 778 can also couple the electrical contacts 762, 766, 770, 774 to a negatively charged voltage source.

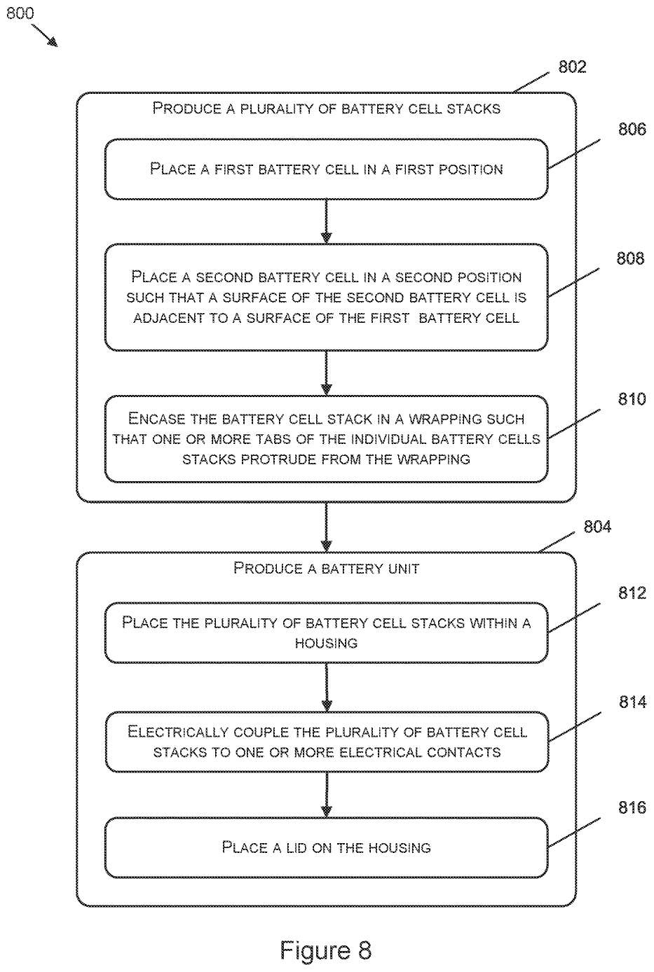

FIG. 8 is a flow diagram illustrating a process 800 to produce a plurality of battery cell stacks and to produce a battery unit that includes the plurality of battery cell stacks, in accordance with one or more example implementations. The process 800 can include, at 802, producing a plurality of battery cell stacks. Individual battery cell stacks of the plurality of battery cell stacks can be assembled by producing an arrangement of battery cells and electrically coupling the battery cells included in the arrangement. Additionally, at 804, the process 800 can include producing a battery unit. The battery unit can comprise at least a portion of the plurality of battery cell stacks produced with respect to 802.

In one or more examples, producing the plurality of battery cell stacks at 802 can include, at 806, placing a first battery cell in a first position. In at least some examples, placing the battery cell in the first position can include placing the first battery cell on a surface. In one or more additional examples, placing the battery cell in a first position can include suspending the first battery cell above a surface. At 808, the process 800 can include placing a second battery cell in a second position. In one or more examples, the second battery cell can be placed in a second position such that a surface of the second battery cell is adjacent to a surface of the first battery cell. In various examples, the surface of the first battery cell can be directly contacting the surface of the second battery cell. In one or more illustrative examples, a bottom surface of the first battery cell can be in direct contact with a top surface of the second battery cell. In one or more additional illustrative examples, a top surface of the first battery cell can be in direct contact with a top surface of the second battery cell. In one or more further illustrative examples, the plurality of battery cell stacks can individually be produced according to arrangements described with respect to FIG. 3. To illustrate, the plurality of battery cells can be stacked in alternating orientations with top surfaces of one or more pairs of battery cells contacting one another and bottom surfaces of one or more additional pairs of battery cells contacting one another. Additionally, the plurality of battery cell stacks can individually be produced according to arrangements described with respect to FIG. 4. For example, the plurality of battery cells can be stacked sequentially and in the same orientation, such that the top surfaces and bottom surfaces of pairs of battery cells are contacting one another.

In at least some examples, the first battery cell and the second battery cell can be placed in one or more positions using one or more gripper devices. The one or more gripper devices can include an automated or robotic apparatus that includes a gripping component. The gripping component can operate using suction to draw the first battery cell and the second battery cell to a surface of the gripping component. In various examples, the amount of suction applied to hold the first battery cell and the second battery cell to the surface of the gripping component can be no greater than 100 kilopascals (kPa), no greater than 80 kPa, no greater than 60 kPa, no greater than 50 kPa, no greater than 40 kPa, no greater than 30 kPa, no greater than 20 kPa, no greater than 10 kPa, no greater than 5 kPa, or no greater than 1 kPa. In one or more illustrative examples, the amount of suction applied to hod the first battery cell and the second battery cell to the surface of the gripping component can minimize any damage or warping to one or more layers of the first battery cell and the second battery cell. After the first battery cell and the second battery cell have been placed in the battery cell stack, the one or more gripper devices holding the first battery cell and the second battery cell can release the first battery cell and the second battery cell by removing the suction applied to the first battery cell and the second battery cell by the one or more gripper devices. In various examples, after the first battery cell and the second battery cell have been positioned according to an arrangement of the battery cell stack, the operations 806 and 808 can be repeated for one or more additional battery cells until the battery cell stack is produced that includes a number of battery cells. At least a portion of the battery cells included in the battery cell stack can be coupled to one another.

At operation 810, the process 800 can include encasing the battery cell stack in a wrapping. The wrapping can be comprised of one or more electrically insulating materials. In one or more illustrative examples, the wrapping can include one or more plastic material. Additionally, the battery cell stack can include one or more tabs for coupling at least one of anode layers or cathode layers of the battery cell stack to a load. The one or more tabs can extend beyond the wrapping.

In one or more examples, the layers of the battery cells can include a cathode foil and an anode foil as the outermost layers of the individual battery cells and are disposed opposite each other in the battery cells. An anode layer can be disposed adjacent to the anode foil and a cathode layer can be disposed adjacent to the cathode foil. Additionally, an electrolyte can be disposed between the cathode layer and the anode layer. In one or more illustrative examples, the anode foil can include one or more copper materials and the cathode foil can include one or more aluminum materials. The electrolyte can include a solid-state electrolyte. For example, the electrolyte can include a ceramic electrolyte. In one or more additional illustrative examples, the electrolyte can include lithium lanthanum zirconium oxide (LLZO). In various examples, one or more layers of the battery cells, such as at least one of the anode foil or the cathode foil, can have a thickness from 1 micrometer to 20 micrometers or from 3 micrometers to 10 micrometers. In one or more further examples, the anode layer can include a lithium metal. In at least some examples, the lithium metal can have a purity of at least 75% at least 80%, at least 85%, at least 90%, at least 95%, or at least 99%.

In various examples, the layers included in individual battery cells of the battery cell stacks can be arranged in a vertically oriented stack and have an amount of overlap with respect to each other that is at least 80%, at least 85%, at least 90%, at least 95%, or at least 90%. In one or more examples, at least one of one or more anode foils or one or more cathode foils can include a tab that is located at least partially outside of the areas of overlap between the layers of the battery cells included in the battery cell stack. In one or more additional examples, the surface area of one or more layers of the battery cells included in the battery cell stack can be from 100 millimeters squared (mm²) to 250,000 mm², from 400 mm² to 10,000 mm², or from 2000 mm² to 5000 mm². In one or more further example, a voltage applied between an anode foil and a cathode foil of one or more battery cells included in the battery cell stack can be from 1 V to 6 V. In still other examples, the number of battery cells included in the battery cell stack can be from 5 battery cells to 100 battery cells, from 10 battery cells to 75 battery cells, from 20 battery cells to 50 battery cells, from 5 battery cells to 25 battery cells, or from 50 battery cells to 100 battery cells.

At operation 812, the process 800 includes placing the plurality of battery cell stacks produced with respect to 802 within a housing. The housing can include a body and a hollow space within the body. The plurality of battery cell stacks can be placed within at least a portion of the hollow space. In one or more examples, the plurality of battery cell stacks can be individually placed into the housing using one or more gripper devices.

Additionally, at 814, the process 800 can include electrically coupling the plurality of battery cell stacks to one or more electrical contacts of the housing. In various examples, the plurality of battery cell stacks can be electrically coupled to each other before being electrically coupled to one or more electrical contacts related to the housing. the Further, at 816, the process 800 can include placing a lid on the housing. The lid can cover at least about 50%, at least about 75%, at least about 80%, at least about 85%, at least about 90%, at least about 95%, or at least about 99% of an opening of the housing. In various examples, the lid can be secured to the housing using at least one of laser welding, ultrasonic vibration welding, or friction welding.

In one or more examples, at least one of the housing or the lid can include an anode electrical contact and a cathode electrical contact. In one or more illustrative examples, the lid can include an anode electrical contact and a cathode electrical contact. In one or more additional examples, the anode electrical contact can be located on a first surface of the housing or on the lid and the cathode electrical contact can be located on an opposite surface of the housing or the lid. In various examples, the housing can have a substantially cubic shape. In one or more further examples, the housing can include a bottom component or lower part that applies a mechanical stress in an axial direction. The mechanical stress can be applied using a spring-like mechanism. the spring-like mechanism can include one or more springs, an elastic component, a cushion, or one or more combinations thereof. In still other examples, the spring-like mechanism can be implemented as an s-curve displacement of a bottom surface of the housing with respect to the bottom component. In one or more examples, a volume of the housing can be greater than a volume occupied by the battery cell stacks by from 1% to 10% to accommodate the bottom component or lower part.

In at least some examples, the battery cell stacks included in the battery unit can be electrically coupled in a parallel arrangement. In one or more additional examples, the battery cell stacks included in the battery unity can be electrically coupled in a series arrangement. In various examples, the battery cell stacks included in the battery unit can be encased in a wrapping. The wrapping can include one or more electrically insulating materials. Additionally, the battery unit can include a cathode tab and an anode tab that extend outside of the wrapping. In one or more illustrative examples, the battery unit can include from 5 battery cell stacks to 100 battery cell stacks, from 10 battery cells to 50 battery cells, or from 8 battery cell stacks to 20 battery cell stacks. In one or more additional illustrative examples, a voltage of the battery unit can be from 5V to 60V or from 24V to 48V. In one or more further illustrative examples, a voltage of the battery unit can correspond to a voltage of an individual battery cell stack. In still other illustrative examples, the voltage of an individual battery cell stack can be from 1V to 6V or from 3.5V to 5V.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is an apparatus comprising: a battery unit that includes a plurality of battery cells with individual battery cells of the plurality of battery cells comprising an anode, an anode foil, a cathode, a cathode foil, and an electrolyte, wherein the cathode foil and the anode foil are the outermost layers of the individual battery cell, the anode is disposed adjacent to the anode foil, the cathode is disposed adjacent to the cathode foil, and the electrolyte is disposed between the anode and the cathode.

In Example 2, the subject matter of example 1, includes: a first cathode foil of a first battery cell of the plurality of battery cells being electrically connected to a second cathode foil of a second battery cell of the plurality of battery cells; and a first anode foil of the first battery cell being electrically connected to a second anode foil of the second battery cell.

In Example 3, the subject matter of any one of examples 1 or 2, includes the anode foil comprising copper and the cathode foil comprising aluminum.

In Example 4, the subject matter of any one of examples 1-3, includes the electrolyte being a solid-state electrolyte.

In Example 5, the subject matter of example 4, includes the solid-state electrolyte comprising lithium lanthanum zirconium oxide (LLZO).

In Example 6, the subject matter of any one of examples 1-5, includes the anode foils having a height from about 1 micron to about 20 microns and the cathode foils having a height from about 1 micron to about 20 microns.

In Example 7, the subject matter of any one of examples 1-6, includes the anode comprising a lithium metal.

In Example 8, the subject matter of any one of examples 1-7, includes the anode comprising a composition having a lithium purity of greater than 90%.

In Example 9, the subject matter of any one of examples 1-8, includes first values of dimensions of first layers of a first battery cell of the plurality of battery cells being within about 95% of second values of dimensions of second layers of a second battery cell of the plurality of battery cells.

In Example 10, the subject matter of any one of examples 1-9, includes at least one cathode foil and at least one anode foil comprising tabs that extend from a functional area of the at least one cathode foil and the at least one anode foil.

In Example 11, the subject matter of any one of examples 1-10, includes a surface area of the layers of the plurality of battery cells being between 2000 mm² and 5000 mm².

In Example 12, the subject matter of any one of examples 1-11, includes a voltage being applied between the anode foil and cathode foil having values between 1 volt (V) and 6 V.

In Example 13, the subject matter of any one of examples 1-12, includes the battery unit comprising between 10 and 50 battery cells.

Example 14 is an apparatus comprising: a battery unit comprising a plurality of battery cells, wherein the plurality of battery cells are arranged in a stack according to an order from a top of the battery unit to a bottom of the battery unit such that a first separator layer of a first battery cell of the plurality of battery cells is disposed below a first anode layer and above a first cathode layer and a second separator layer of a second battery cell of the plurality of battery cells is disposed below the first cathode layer and above a second anode layer, wherein: individual battery cells of the plurality of battery cells include at least one tab; first tabs of anodes are in direct contact with each other and second tabs of cathodes are in direct contact with each other; the number of battery cells included the stack is from 10 to 50; and a voltage supplied by the battery unit corresponds to a voltage of an individual battery cell.

Example 15 is an apparatus comprising: a battery unit comprising a plurality of battery cells, wherein the plurality of battery cells are arranged in a stack according to an order from a top of the battery unit to a bottom of the battery unit such that a first separator layer of a first battery cell of the plurality of battery cells is disposed below a first anode layer and above a first cathode layer and a second separator layer of a second battery cell of the plurality of battery cells is disposed below a second cathode layer and above a second anode layer, wherein: a portion of the individual battery cells of the plurality of battery cells include a tab and the tabs of the battery cells that have a tab contact one another; first tabs of anodes are in direct contact with each other and second tabs of cathodes are in direct contact with each other; the number of battery cells included the stack is from 8 to 20; and a voltage supplied by the battery unit is from about 5 V to about 24 V.

In Example 16, the subject matter of example 15, includes the battery unit being encased in an electrical insulating material and the battery unit has two tab areas extending from the electrical insulating material.

In Example 17, the subject matter of example 15 or 16, including the battery cells being connected in series by a plurality of tabs of the respective battery cells.

In Example 18, the subject matter of any one of examples 15-17, includes the battery cells being connected in parallel by a plurality of tabs of a portion of the battery cells.

In Example 19, the subject matter of any one of examples 15-18, includes the battery unit including a plurality of stacks of battery cells and dimensions of the plurality of stacks of battery cells are within at least about 90% of each other.

In Example 20, the subject matter of example 19, includes the battery unit having at least a substantially cubic shape.

In Example 21, the subject matter of any one of examples 15-20, includes the battery unit comprising a housing including a lower component and a lid with the lower component including a device that applies a mechanical stress in an axial direction perpendicular to surfaces of the battery cells.

In Example 22, the subject matter of example 21, includes the device including a spring-like device realized by a s-curved displacement of a bottom surface of the housing to the inside of the bottom component.

In Example 23, the subject matter of example 21, includes the lid comprising two terminals that are electrically insulated against the rest of the housing and the position of the terminals on the lid are such that the centers of the terminals are on the diagonal between two corners of the lid.

Example 24 is a method for manufacturing a deck of battery stack including a plurality of battery cells, comprising: a) placing the layers according to claim I on each other by use of grippers that interact with the layers in a reversible manner, in particular by vacuum below 100 millibars against ambient conditions; b) repeating step a) at least 2 times to stack more than one battery cell on another to form a battery stack; c) wrapping an electrical insulating foil around the battery stack in a way that a tab area of the battery stack is not covered by the insulating foil.

Example 25 is a method for positioning a battery stack comprised of a plurality of battery cells in a housing, comprising: a) gripping a battery stack that has been wrapped with an insulating material by mechanical means and positioning in the battery stack in a hollow lower part of the housing; b) establishing an electrical connection to an electrical connector provided in the hollow lower part either after or before such positioning; c) placing a lid on top of the hollow lower part of the housing such that the lid covers at least 65% of the hollow lower part; and d) establishing a tight connection between the lid and the hollow lower part by means of welding by laser or ultrasonic vibration or by friction welding.

In Example 26, the subject matter of example 25, includes establishing an electrical connection to the electrical connector and the terminals either before or after establishing the electrical connection to the electrical connector in b ).

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of configurations described in the specification.

It will be apparent to those skilled in the art that various modifications and variations may be made without departing from the scope. Other configurations will be apparent to those skilled in the art from consideration of the specification and practice described herein. It is intended that the specification and described configurations be considered as exemplary only, with a true scope being indicated by the following claims.

1. An apparatus comprising:
a battery unit that includes a plurality of battery cells with individual battery cells of the plurality of battery cells comprising an anode, an anode foil, a cathode, a cathode foil, and an electrolyte,
wherein the cathode foil and the anode foil are the outermost layers of the individual battery cell, the anode is disposed adjacent to the anode foil, the cathode is disposed adjacent to the cathode foil, and the electrolyte is disposed between the anode and the cathode.

2. The apparatus of claim 1, wherein:
a first cathode foil of a first battery cell of the plurality of battery cells is electrically connected to a second cathode foil of a second battery cell of the plurality of battery cells; and
a first anode foil of the first battery cell is electrically connected to a second anode foil of the second battery cell.

3. The apparatus of claim 1, wherein the anode foil comprises copper, the cathode foil comprises aluminum, and the electrolyte is a solid-state electrolyte.

4. (canceled)

5. The apparatus of claim 4, wherein the solid-state electrolyte comprises lithium lanthanum zirconium oxide (LLZO).

6. The apparatus of claim 1, wherein the anode foils have a height from about 1 micron to about 20 microns and the cathode foils have a height from about 1 micron to about 20 microns.

7. (canceled)

8. The apparatus of claim 1, wherein the anode comprises a composition having a lithium purity of greater than 90%.

9. The apparatus of claim 1, wherein first values of dimensions of first layers of a first battery cell of the plurality of battery cells are within about 95% of second values of dimensions of second layers of a second battery cell of the plurality of battery cells.

10. The apparatus of claim 1, wherein at least one cathode foil and at least one anode foil comprise tabs that extend from a functional area of the at least one cathode foil and the at least one anode foil.

11. The apparatus of claim 1, wherein a surface area of the layers of the plurality of battery cells is between 2000 mm² and 5000 mm².

12. The apparatus of claim 1, wherein a voltage is applied between the anode foil and cathode foil having values between 1 volt (V) and 6 V.

13. The apparatus of claim 1, wherein the battery unit comprises between 10 and 50 battery cells.

14. (canceled)

15. An apparatus comprising:
a battery unit comprising a plurality of battery cells, wherein the plurality of battery cells are arranged in a stack according to an order from a top of the battery unit to a bottom of the battery unit such that a first separator layer of a first battery cell of the plurality of battery cells is disposed below a first anode layer and above a first cathode layer and a second separator layer of a second battery cell of the plurality of battery cells is disposed below a second cathode layer and above a second anode layer, wherein:
a portion of the individual battery cells of the plurality of battery cells include a tab and the tabs of the battery cells that have a tab contact one another;
first tabs of anodes are in direct contact with each other and second tabs of cathodes are in direct contact with each other;
the number of battery cells included the stack is from 8 to 20; and
a voltage supplied by the battery unit is from about 5 V to about 24 V.

16. The apparatus of claim 15, wherein the battery unit is encased in an electrical insulating material and the battery unit has two tab areas extending from the electrical insulating material.

17. The apparatus of claim 15, wherein the battery cells are connected in series by a plurality of tabs of the respective battery cells.

18. The apparatus of claim 15, wherein the battery cells are connected in parallel by a plurality of tabs of a portion of the battery cells.

19. The apparatus of claim 15, wherein the battery unit includes a plurality of stacks of battery cells and dimensions of the plurality of stacks of battery cells are within at least about 90% of each other, such that the battery unit has at least a substantially cubic shape.

20. (canceled)

21. The apparatus of claim 15, wherein the battery unit comprises a housing including a lower component and a lid with the lower component including a device that applies a mechanical stress in an axial direction perpendicular to surfaces of the battery cells.

22. The apparatus of claim 21, wherein the device includes a spring-like device realized by a s-curved displacement of a bottom surface of the housing to the inside of the bottom component.

23. The apparatus of 21, wherein the lid comprises two terminals that are electrically insulated against the rest of the housing and the position of the terminals on the lid are such that the centers of the terminals are on the diagonal between two corners of the lid.

24. A method for manufacturing a deck of battery stack including a plurality of battery cells, comprising:
a) placing the layers according to claim 1 on each other by use of grippers that interact with the layers by vacuum below 100 millibars against ambient conditions;
b) repeating step a) at least 2 times to stack more than one battery cell on another to form a battery stack;
c) wrapping an electrical insulating foil around the battery stack in a way that a tab area of the battery stack is not covered by the insulating foil.

25. (canceled)

26. (canceled)
